(19) United States
(12) Patent Application Publication
(10) Pub. No.: US 2014/0272295 A1
(43) Pub. Date: Sep. 18, 2014

(54) ANTI-FOG NANOTEXTURED SURFACES AND ARTICLES CONTAINING THE SAME

(71) Applicant: SDC TECHNOLOGIES, INC., Irvine, CA (US)

(72) Inventors: Kiranmayi Deshpande, Lake Forest, CA (US); Sapna Blackburn, Mission Viejo, CA (US); Masanori Iwazumi, Irvine, CA (US)

(73) Assignee: SDC TECHNOLOGIES, INC., Irvine, CA (US)

(21) Appl. No.: 13/828,073

(22) Filed: Mar. 14, 2013

(51) Int. Cl. G02B 1/12; G02C 7/04

(52) U.S. Cl. CPC G02B 1/12; G02C 7/049
USPC 428/142; 428/141

(57) ABSTRACT

Disclosed herein are anti-fog, transparent nanotextured surfaces for transparent substrates. Also disclosed are articles comprising substrates having the anti-fog transparent nanotextured surfaces formed thereon.

### FIELD OF THE DISCLOSURE

This disclosure relates to anti-fog, transparent nanotextured surfaces. This disclosure also relates to articles containing transparent substrates that have such surfaces formed thereon.

### BACKGROUND

Fogging can be troublesome for transparent substrates, such as ophthalmic lenses, goggles, face shields, face plates for helmets, automobile windshields, solar panel shields, and the like, as it reduces clarity and transparency through the substrate. Fog appears when moisture condenses on a surface of the substrate and is drawn into tiny droplets that scatter light. This occurs when the substrate is at a lower temperature than that of its surrounding environment. For ophthalmic lenses and other transparent substrates, anti-fog coatings may be applied to reduce or eliminate fogging. Such anti-fog coatings are typically hydrophilic in nature and act to spread or sheet the water across the surface of the substrate in an effect called “wetting.”

The hydrophilic types of anti-fog coatings typically have chemicals such as surface active agents (also known as “surfactants”) present in the formulation that act to lower the surface tension of water on the substrate, thereby causing it to sheet-out across the surface, i.e., “wet” the surface, instead of condensing into droplets. The resulting water-sheeting effect minimizes the formation of water droplets that scatter the light, and consequently, the occurrence of fog, resulting in improved visibility through the transparent substrate. The anti-fog hydrophilic surfaces that cause water to sheet-out across the surface typically exhibit contact angles with water of less than 90°, more typically around 10°. In certain instances, a hydrophilic coating or a hydrophilic surface may also prevent water droplets from forming by absorbing the water into the coating or surface itself.

Typically, these types of anti-fog coatings require large amounts of surfactants to impart a long lasting, anti-fog effect on the substrate. This is because the surfactants in such coatings are generally only physically associated with the coatings, i.e., physically trapped within the polymer network of the coating, and wash off or leach away over time, thereby resulting in temporary anti-fog properties for the surface of the coating. Furthermore, the use of large amounts of surfactants may adversely impact the mechanical strength of the coatings.

### SUMMARY

Disclosed herein are anti-fog and transparent nanotextured surfaces for transparent substrates. Also disclosed are articles comprising transparent substrates having the anti-fog transparent nanotextured surfaces formed thereon.

In accordance with the embodiments of this disclosure, the anti-fog transparent nanotextured surfaces comprise an array of vertical pillars. The array of vertical pillars comprises a surface fraction (Øₛ) of the array of from 14% to 65%; an average pitch of the array from 45 to 125 nm; an average height of the pillars from 50 to 150 nm; and a roughness from 2.5 to 7.5. In accordance with certain embodiments, the nanotextured surfaces are superhydrophobic.

In accordance with other embodiments, articles comprising a transparent substrate and at least a portion of a nanotextured surface disclosed herein formed on the substrate.

### BRIEF DESCRIPTION OF THE DRAWINGS

FIG. 1 shows a perspective view of a portion of an array of vertical pillars having a circular cross section in accordance with embodiments of the nanotextured surface disclosed herein.

FIG. 2 shows a perspective view of a portion of an array of vertical pillars having a square cross section in accordance with embodiments of the nanotextured surface disclosed herein.

FIG. 3A is a top view scanning electron microscopy image of the nanotextured surface in accordance with Example 1.

FIG. 3B is a top view scanning electron microscopy image of the nanotextured surface in accordance with Comparative Example 1.

FIG. 4 shows a cross section of a portion of an article comprising a transparent substrate and a nanotextured surface formed on the substrate in accordance with embodiments disclosed herein.

FIG. 5 shows a side view cross section of a portion of an array of vertical pillars having rounded apexes in accordance with embodiments of the nanotextured surface disclosed herein.

FIG. 6 shows the reflectance spectra, i.e., wavelength versus percent reflectance, in accordance with Example 1B, Comparative Example 1B, and Control B.

### DETAILED DESCRIPTION

Disclosed herein are anti-fog transparent nanotextured surfaces for transparent substrates. Also disclosed are articles comprising transparent substrates having the anti-fog transparent nanotextured surfaces formed thereon.

In accordance with the embodiments disclosed herein, the nanotextured surface comprises an array of vertical pillars, i.e., vertical nanopillars. The vertical pillars of the array have an average height (“h_{avg}”) ranging from 50 to 150 nm and an average pitch (“p_{avg}”) ranging from 45 to 125 nm. In general, the teen “pitch” refers to the center-to-center distance between the pillars in the array. Thus, the average pitch (p_{avg}) of the array is the average center-to-center distance for all of the pillars in the array. In accordance with certain embodiments, the individual pitches between the pillars in the array may be the substantially the same or may vary throughout the array so long as the average pitch taken over the individual pitches meets the aforementioned value, i.e., p_{avg} ranges from 45 to 125 nm. Unless otherwise indicated herein, the phrase “substantially the same” refers to dimensions or parameters that have minor differences due to manufacturing tolerances and processes, but otherwise have the same intended design parameter. Typically, arrays that have substantially the same individual pitches have a regular periodicity, i.e., arrangement of rows and columns, of the pillars in the array. Conversely, arrays that have varying individual pitches may have an uneven periodicity of the vertical pillars within the array, at least as compared to those having substantially the same individual pitches of the pillars. In accordance with certain embodiments, preferably, the arrays have substantially the same individual pitches between the vertical pillars in the array. Furthermore, in accordance with certain preceding embodiments, the arrays have a regular periodicity of the pillars in the array.

The vertical pillars of the array have substantially the same shape within the array. The shapes of the vertical pillars are characterized by the height and the lateral cross sectional profiles of the pillars. Unless otherwise indicated herein, the phrase “substantially the same shape” refers to pillars having the identical design parameters, i.e., the same design parameters for the height as well as the same design parameters for the lateral cross sections of the pillars, but have minor differences in actual shape due to manufacturing tolerances and processes. Nonlimiting examples of suitable shapes of the vertical pillars according to embodiments disclosed herein include pillars having circular or equiangular polygonal lateral cross sections. As used herein, the term “equiangular polygonal” refers to a polygonal shape in which all vertex angles are equal. Non-limiting examples of equiangular polygonal shapes suitable for the lateral cross sections of the pillars disclosed herein include equiangular triangles; equiangular quadrilaterals such as rectangles and squares; equiangular pentagons, equiangular hexagons, and the like. As used herein, the shape of the lateral cross section of the pillar, e.g., circular or equiangular polygons such as squares, rectangulars, etc., refers to the design parameters for the cross section. One of ordinary skill in art would understand the due to manufacturing tolerances and processes, the actual lateral cross sections may deviate from actual circles and equiangular polygons (such as squares and polygons), e.g., the actual manufactured profiles may have minor deviations causing circles to be ellipses, and for equiangular polygons such as squares and rectangles, the actual cross sections may be trapezoids or non-square/non-rectangular parallelograms, etc. Preferably, the lateral cross section of individual pillars in the arrays disclosed herein is circular, rectangular, or square. Moreover, in accordance with embodiments disclosed herein, preferably, the upper surface, e.g., apex or peak, of the vertical pillars has a rounded, e.g., semi-spherical, shape. Unless otherwise indicated herein, the rounded upper surface of the pillars is referred to as the “rounded apex” of the pillar.

FIGS. 1, 2, and 5 show different views of arrays in accordance with embodiments of the nanotextured surfaces disclosed herein. FIG. 1 shows a perspective view of a portion of an array 10 containing vertical pillars 11 having a circular lateral cross section. Pillars 11 have an upper surface 12 and a base 13. In accordance with the embodiments disclosed herein, when the vertical pillars have a circular lateral cross section, e.g., pillars 11, the pillars generally have a height “h,” a diameter “d,” and a pitch “p” as shown in FIG. 1.

FIG. 2 shows a perspective view of a portion of an array 20 containing vertical pillars 21 having a square lateral cross section. Pillars 21 have an upper surface 22 and a base 23. In accordance with the embodiments disclosed herein, when the pillars have a square lateral cross section, e.g., pillars 21, the pillars generally have a height “h,” a side length “a,” and a pitch “p.”

FIG. 5 shows a vertical, i.e., side view, cross section of a portion of an array 50 of pillars 51. Pillars 51 have a rounded apex, i.e., upper surface 52. If the vertical pillars in the array have rounded apexes 52, the height (“h”) of the pillar 51 is measured between the base of the apex 54 to the base of the pillar 53 as shown in FIG. 5.

Unless otherwise indicated herein, the term “lateral cross section” of the vertical pillars disclosed herein refers to the cross section taken along a lateral axis of the pillar such as axis A-A of the vertical pillars as shown in FIGS. 1, 2, and 5. In accordance with the embodiments disclosed herein, the lateral cross sectional area of each vertical pillar 11, 21, or 51 is substantially uniform along the height (h) of the pillar, e.g., the area of the lateral cross section of the pillar 11, 21, or 51 has substantially the same lateral cross sectional area at the base of the pillar 13 or 23 along the height (h) of the pillar up to upper surface 12 or 22 if the pillar 11 or 21 has a flat surface, or up to the base of the apex 54 if the pillar 51 has a rounded apex 52.

FIG. 3A, which is a scanning electron microscopy image of the nanotextured surface in accordance with Example 1, illustrates an example arrangement of the pillars, notably showing an example periodicity of the pillars, from a top view of an array in accordance with the embodiments disclosed herein.

In accordance with the embodiments disclosed herein, the nanotextured surfaces have an array with a surface fraction (Øₛ) of greater than 13%, including from 14% to 65%, preferably from 19% to 65%, and more preferably from 24% to 65%. The surface fraction (Øₛ) is the ratio of the lateral cross sectional area of the pillars to the total area bearing the pillars, where the total area bearing the pillars includes the area under and between the pillars in the array (specifically, the total area bearing the pillars is p_{avg}²). The surface fraction generally represents the total surface area in contact with a liquid droplet in a “Cassie-Baxter” (also known as fakir) state of the disclosed nanotextured surfaces, which is discussed infra in greater detail.

For example, in accordance with certain embodiments disclosed herein, the surface fraction of an array having a circular lateral cross section is determined by formula (I) below,

Øₛ=πd_{avg}²/4p_{avg}² (I)

where “d_{avg}” is the average diameter of circular lateral cross section of the pillars in the array and “p_{avg}” is the average pitch of the array, i.e., the average center-to-center distance between the pillars in the array.

In accordance with other embodiments, the surface fraction of an array comprising pillars having a square lateral cross section is determined by formula (II) below:

Øₛ=a_{avg}²/p_{avg}² (II)

where “a_{avg}” is the average length of a side of the square lateral cross section of the pillars in the array and “p_{avg}” is the average pitch as described above. Those skilled in the art can determine the surface fraction of an array according to the embodiments disclosed herein having a lateral cross section shape different than a circle or square.

In accordance with the embodiments disclosed herein, the nanotextured surfaces have an array with a roughness ranging from 2.5 to 7.5. The roughness represents a measure of the vertical deviations of a surface from its ideal, i.e., smooth, form. As used herein, the roughness is a ratio of the sum of total area bearing the pillars (i.e., p_{avg}²) and the vertical surface area of the pillars (i.e., the surface area along the height (h) of the pillar) to the ideal surface area (i.e., the total area bearing the pillars: p_{avg}²).

For example, in accordance with certain embodiments disclosed herein, the roughness of an array having a circular lateral cross section is determined by formula (III) below:

r=1+πd_{avg}h_{avg}/p_{avg}² (III)

where “d_{avg}” is the average diameter as described above, “p_{avg}” is the average pitch as described above, and “h_{avg}” is the average height of the pillars in the array. In accordance with other embodiments, when the pillars of the array have a square lateral cross section, the roughness of the array is determined by formula (IV):

r=1+4a_{avg}h_{avg}/p_{avg}² (IV)

where “a_{avg}” is the average length of a side of the square lateral cross section of the pillars in the array as discussed above, “h_{avg}” is the average height of the pillars as discussed above, and “p_{avg}” is the average pitch as described above. Those skilled in the art can determine the roughness of an array according to the embodiments disclosed herein having a lateral cross section shape different than a circle or square.

In accordance with certain embodiments disclosed herein, the average pitch of array ranges from 45 to 125 nm, preferably from 60 to 125 nm, and more preferably from 75 to 125 nm. The average height of the pillars in the array ranges from 50 to 150 nm, preferably from 50 to 125 nm, and more preferably from 75 to 100 nm. In certain embodiments when the pillars of the array have a circular lateral cross section, the average diameter of pillars in the array is from 25 to 100 nm, preferably from 50 to 100 nm, and more preferably from 50 to 75 nm. In certain embodiments when the pillars of the array have a square lateral cross section, the average length of a side of the square lateral cross section of the pillars ranges from 25 to 100 nm, preferably from 50 to 100 nm, and more preferably from 50 to 75 nm.

Typically, the pitch of the vertical pillars in the array have an effect on the reflectiveness of the surface. Because the dimensions of the nanotextured surfaces disclosed herein, namely, the average pitch having values ranging from 45 to 125 nm, are well below half of that of the wavelength of visible light, which approximately ranges from 400 nm to 800 nm, the occurrence of reflection off of the nanotexturized surfaces disclosed herein is minimized. In accordance with certain embodiments disclosed herein, the nanotextured surfaces have a percent reflectance that is less than or equal to the percent reflectance of a comparable surface without the nanotexture, where the comparable surface is the same material as the nanotextured surface but without the nanotexture disclosed herein.

In accordance with certain embodiments disclosed herein, the nanotextured surface is superhydrophobic. A “superhydrophobic” surface, as used herein, refers to a surface on which a water drop takes up a spherical shape having a contact angle ranging from 130° to 165° or more. The nanotexture of the surface described herein facilitates providing superhydrophobicity to the surface. The presence of air pockets in interstices of the surface below the water droplets, e.g., the interstices between the pillars according to the dimensions described herein, facilitates the formation of high, superhydrophobic contact angles in the water droplets, e.g., contact angles ranging from 130° to 165°. This state, i.e., where a water droplet is positioned over air pockets in the roughness of the surface texture, is referred to as a “Cassie-Baxter” or a “fakir” state. The superhydrophobic nanotextured surfaces disclosed herein provide a surface having a contact angle ranging from 130° to greater than 150°, including contact angles ranging from 130° to 150°, thereby indicating that static water droplets on the surface, if any, exist in a Cassie-Baxter state.

As mentioned above, when a surface has a lower temperature than its environment, fog appears as the result of moisture condensing on the surface and the moisture being drawn into water droplets that scatter light. Conventional anti-fog coatings, i.e., anti-fog surfaces, are typically hydrophilic in nature and work by “wetting” the surface, i.e., lowering the surface tension of the water droplets, thereby causing the water to sheet-out across the surface. Alternatively or in addition, the hydrophilic surface may prevent water droplets from forming by absorbing the water into the surface itself. Superhydrophobic surfaces, in contrast, interact with water in a different manner than anti-fog hydrophilic surfaces do by promoting the creation of water droplets on the surface, i.e., in effect, superhydrophobicity is the opposite of “wetting” the surface. For large water droplets such as rain, e.g., a droplet having a diameter from 0.5 to 8 mm, it is well known that superhydrophobic surfaces, including those that provide the Cassie-Baxter state, function as water repellant surfaces. In particular, water-repellant superhydrophobic surfaces facilitate the easy roll-off of the larger water droplets, which have high contact angles, as the large droplets form on the surface. However, water repellant superhydrophobic surfaces, including those that provide the Cassie-Baxter state, do not necessarily function as anti-fog surfaces, because the water droplets that cause fogging exist on a much smaller scale than the aforementioned larger droplets associated with water repellant surfaces. In particular, the droplets that cause fogging have a diameter several magnitudes smaller, e.g., fog causing droplets having a diameter about 0.1 to 8 microns (or 1×10⁻⁴ to 8×10⁻³ mm), which is much smaller than the water droplets associated with the water-repellant effect, e.g., 0.5 to 8 mm. For the superhydrophobic nanotextured surfaces disclosed herein, it is surprising that the superhydrophobic surfaces are resistant to fogging.

In accordance with certain embodiments disclosed herein, the nanotextured surface comprises at least one layer of a hardened composition. Examples of suitable hardened compositions include, but are not limited to, quartz, glass, silicon, silicon dioxide, silicon nitride, metals, sapphire, diamond film, ceramics, and the like. As used herein, the term “hardened” refers to a composition that is initially hard or rigid, and in some embodiments, already cured, such as a polymer. In accordance with certain embodiments disclosed herein, a nanotextured surface comprising at least one layer of a hardened composition is used as a mask for a nanotexture mold.

In accordance with certain embodiments disclosed herein, the nanotextured surface comprises at least one layer of a hardenable composition. As used herein, the term “hardenable” refers to a composition that is initially soft, or softenable in some manner, that cures or otherwise hardens into a final, hardened form. A hardenable composition in accordance with certain embodiments disclosed herein is moldable. In certain of these embodiments, the nanotextured surface is formed, e.g., molded, from the at least one layer of a hardenable composition. Examples of suitable hardenable compositions include, but are not limited to, at least one layer of an organic polymer such as polymethylmethacrylate (PMMA), polyurethane-acrylates, and the like; organic-inorganic hybrid polymers, such as organosiloxanes, e.g., polydimethylsiloxane, and the like; resist resins such as hydrogen silsesquioxane (HSQ); novolac resins such as diazonaphthoquinone (DNQ)-novolac resins; epoxy-based resist resins, and the like; and fluoropolymers, such as a fluorinated ethylenic-cyclo oxyaliphatic substituted ethylenic copolymers (commercially available as TEFLON AF2400 from E. I. du Pont de Nemours and Company of Delaware), a copolymer of ethylene and tetrafluoroethylene (commercially available as TEFZEL from E. I. du Pont de Nemours and Company), and the like. In certain embodiments, the fluoropolymers are the same or different as the fluorosilane hydrophobic layers discussed below. In accordance with certain embodiments disclosed herein, a nanotextured surface comprising at least one layer of a hardenable composition is used as a nanotexture mold.

In accordance with certain embodiments disclosed herein, the nanotextured surface comprises at least one layer of a metal oxide. Non-limiting examples of suitable metal oxides useful for the nanotextured surfaces disclosed herein include silica (SiO₂), alumina, zirconia, titania, tantalum oxides, neodymium oxides, praseodymium oxides, combinations thereof, and the like. In certain of these embodiments, at least one metal oxide layer is formed via vapor deposition. In accordance with certain embodiments, the nanotextured surface comprises at least one layer of a metal oxide, and preferably, the nanotextured surface comprises at least one layer of silica.

In accordance with certain embodiments disclosed herein, the nanotextured surfaces disclosed herein may optionally have at least one hydrophobic layer deposited thereon. In accordance with such embodiments, at least a portion of the nanotextured surface has at least one hydrophobic layer deposited thereon. In accordance with certain of the preceding embodiments, nanotextured surfaces disclosed herein that respectively have at least one hydrophobic layer deposited thereon are superhydrophobic. One skilled in the art would be able to select a suitable thickness of the at least one hydrophobic layer. In accordance with certain of the embodiments disclosed herein that include the optional at least one hydrophobic layer, the thickness of the at least one layer is 1 to 10 nm, preferably 1 to 5 nm.

Examples of suitable compounds for use in the hydrophobic layer are fluorosilane compounds. In accordance with this embodiment, the fluorosilane layers or coatings can be applied to the nanotextured surface by depositing a fluorosilane precursor comprising at least two hydrolyzable groups per molecule. The fluorosilane precursors preferably have fluoropolyether moieties and more preferably perfluoropolyether moieties. Fluorosilanes coatings are well known, see e.g., U.S. Pat. Nos. 5,081,192, 5,763,061, 6,183,872, 5,739,639, 5,922,787, 6,337,235, 6,277,485, and EP 0933377, the entire contents of all of which are incorporated by reference herein.

Non-limiting examples of suitable fluorosilane compounds used as the hydrophobic coatings disclosed herein include those represented by the formula (V) below:

R_{P}[R¹SiY₃₋ₙRₙ²]ₘ (V)

where R_{P} is a monovalent or divalent perfluoropolyether group; where R¹ is a divalent alkylene, arylene or a combination of these two, and where R¹ contains 2 to 16 carbon atoms and further optionally contains one or several heteroatoms or functional groups or further optionally is substituted by a halogen; where R² is an alkyl group containing 1 to 4 carbon atoms; where Y is a halogen atom, an alkoxy group containing 1 to 4 carbon atoms, preferably methoxy or ethoxy, or an acyloxy group represented by —OC(O)R₃, where R₃ is an alkyl group containing 1 to 4 carbon atoms; where n is 0, 1, or 2; and where m is 1 (when R_{P} is monovalent) or 2 (when R_{P} is divalent). In certain embodiments, the fluorosilane compounds have a number average molecular weight of at least 1000. Preferably, in certain embodiments, Y is an alkoxy group containing 1 to 4 carbon atoms and R_{P} is a perfluoropolyether group.

Examples of other suitable fluorosilanes include those represented by formula (VI):

[chemical structure]

where n is 5, 7, 9 or 11, and where R is an alkyl group containing 1 to 10 carbon atoms. Other examples include CF₃(CF₂)₅CH₂CH₂Si(OC₂H₅)₃; ((tridecafluoro-1,1,2,2-tetrahydro)octyl-triethoxysilane); CF₃CH₂CH₂SiCl₃; trichloro-1H,1H,2H,2H-perfluorodecylsilane (FDTS); CF₃CF₂(CH₂CH₂)ₙSiCl₃ where n is 5, 7, 9 or 11; and CF₃CF₂CH₂CH₂(SiCl₂R′) where R′ is an alkyl group containing 1 to 10 carbon atoms.

Furthermore, other suitable fluorosilanes for the hydrophobic layer disclosed herein include fluoropolymers having an average molecular weight of 500 to 1×10⁵ represented by formula (VII):

[chemical structure]

where Rf is a perfluoroalkyl group; where Z is a fluoro or trifluoromethyl group; where a, b, c, d and e each are, independently from each other, 0 or an integer greater than or equal to 1, provided that the sum a+b+c+d+e is not less than 1 and that the order of the repeated units between the brackets indexed as a, b, c, d and e is not limited to the order represented; where Y is H or an alkyl group containing 1 to 4 carbon atoms; where X is a hydrogen, bromine or iodine atom; where R¹ is a hydroxyl group or a hydrolysable group; where R² is a hydrogen atom or a monovalent hydrocarbon group; where m is 0, 1 or 2; where n is 1, 2 or 3; and where n is preferably 2.

In accordance with certain embodiments disclosed herein, the nanotextured surfaces may optionally have at least one thin metal layer deposited thereon. Nonlimiting examples of suitable ways of depositing the thin metal layer include ion beam deposition, sputter deposition, and vapor deposition. In accordance with the embodiments disclosed herein that include the optional at least one thin metal layer, the thickness of the layer is from 0.5 to 9 nm.

In accordance with another embodiment, the present disclosure provides articles. The articles disclosed herein comprise a transparent substrate and at least a portion of the nanotextured surface disclosed herein formed on the substrate. Preferably, the transparent substrates are optically clear, i.e., light transmitted through the substrate substantially maintains its optical clarity. Alternatively, or in addition, the transparent substrates are optically clear but with low light transmittance, e.g., tinted substrates. In accordance with certain embodiments disclosed herein, the nanotextured surface is formed directly on the substrate. In accordance with other embodiments, the nanotextured surface is formed on other layers disposed on the substrate between the substrate and the nanotextured surface. Examples of such other layers include, but are not limited to primer layers, abrasion-resistant layers (also known as a hard coat layer), anti-reflective layers, metallic layers, mirror-coat layers, and the like. Those skilled in the art will be able to select suitable types and amounts of such layers between the substrate and the nanotextured surface based on the type of substrate, e.g., a soft or hard substrate, as well as based on the intended use of the substrate, e.g., an ophthalmic lens or a windshield. In accordance with certain embodiments disclosed herein, the nanotextured surface is an outer layer of the article.

In accordance with certain of the preceding embodiments, the nanotextured surface forms at least a portion of another layer on the substrate. For example, in accordance with this embodiment, the nanotextured surface may be formed as an outer surface of a layer disposed on the substrate, such as a hard coat layer or an anti-reflective layer.

Examples of suitable substrates include transparent plastics such as polycarbonate, polarized polycarbonate, polyamide, polyacrylate, polymethacrylate, polyvinylchloride, polybisallyl carbonate, polyethylene terephthalate, polyethylene naphthenate, polyurethane, polysulfides, and polythiourethane. Other substrates include various polyolefins, fluorinated polymers, and glass, such as soda-lime glass, borosilicate glass, acrylic glass among other types of glass, are used with appropriate pretreatments, if necessary. In certain embodiments, the substrates and the nanotextured surfaces formed on at least a portion of the substrates are used in a wide variety of applications. For example, the substrates can include ophthalmic substrates, such as ophthalmic or optical lenses for use in eyeglasses or sunglasses, lenses used in protective eyewear, and the like. These can be used in automotive applications (including automobiles, commercial vehicles, and motorcycles), such as on windshields, windows, instrument gauge coverings, interior surfaces of headlamps, interior surfaces of dome lights, and the like. The substrates can be flat, e.g., planar; curved, e.g., convex or concave; and combinations thereof. In certain of the preceding embodiments, the substrate can be at least partially spherical, e.g., substrates that have a semi-spherical, hemi-spherical, or fully spherical shape. The substrates can be used in applications that often are subjected to or are constantly subjected to humidity or temperature conditions that would tend to cause fogging. Non-limiting examples of applications having such conditions are shields for washroom mirrors, storefront windows, solar panels, and refrigeration units, such as clear refrigerator or freezer doors used in grocery stores or supermarkets.

FIG. 4 shows a non-limiting example of a cross section of a portion of an article 40 comprising a transparent substrate 41 and a nanotextured surface 45 formed on the substrate, in accordance with embodiments disclosed herein. As mentioned above, those skilled in the art will be able to select suitable types and amounts of layers, if any, between the substrate 41 and the nanotextured surface 45, based on the type of substrate as well as based on the intended use of the substrate. For example, the different layers shown in FIG. 4 are typical layers of an ophthalmic lens substrate 41, which can be selected from transparent plastics that are discussed in greater detail, supra. Referring to FIG. 4, a primer layer 42, which is typically a polyurethane-based layer, is disposed in-between the substrate 41 and an abrasion-resistant, hard coat layer 43. Hard coat layers typically are siloxane-based layers. A multi-layer anti-reflective coating 44 may be the next layer. The nanotextured surface 45 may be the topmost layer forming part of the multi-layer anti-reflective coating 44, or the surface 45 may be an additional layer wholly independent to the anti-reflective coating 44. A multilayer anti-reflective coating 44 typically includes at least one low refractive index layer and at least one high refractive index layer, alternating layers of low and high refractive index materials. Thus, layers 44a and 44c in FIG. 4 are typically made of low refractive index material (e.g., SiO₂, SiO₂/Al₂O₃, etc.) while layers 44b and 44d are materials having a high refractive index (e.g., ZrO₂, TiO₂, Ta₂O₅, Nd₂O₅, Pr₂O₅, etc.). If the nanotextured surface 45 is a layer that forms part of the anti-reflective layer 44, then the nanotextured surface layer 45 would typically be made of a low refractive index material (e.g., SiO₂, SiO₂/Al₂O₃, etc.). Those skilled in the art would understand that an article 40 can further include optional layers or treatments not shown in FIG. 4, such as a plasma treatment used between hard coat layer 43 and anti-reflective layer 44, as well as between any of layers of 44a-d and nanotextured surface 45. The nanotextured surface 45 may be coated with the optional hydrophobic layer 46 disclosed herein.

In accordance with embodiments disclosed herein, the nanotextured surface may be produced according to any suitable process known to those skilled in the art which may produce the nanotexture disclosed herein. For example, the surface may be produced using known nanolithography methods, including but not limited to, electron beam lithography (also referred to as e-beam lithography), optical lithography, nanoimprint lithography, X-ray lithography, extreme ultraviolet lithography, charged particle lithography, neutral particle lithography, scanning thermochemical lithography, dip pen nanolithography, and the like. In certain embodiments disclosed herein, a mask containing the nanotextured surface may be used to transfer the nanotexture pattern to a rigid or a flexible mold, which subsequently can then be used to transfer the nanotexture pattern to surface of the substrate, or on any layers positioned between the substrate and the surface to thereby produce the nanotextured surface.

In accordance embodiments disclosed herein, any suitable known method of transferring nanostructures may be used, including those methods described in Xia et al., “Unconventional Methods for Fabricating and Patterning NanoStructures,” Chem. Rev. (1999), 99, pp. 1823-1848; Chou et al. “Nanoimprint Technology,” J. Vac. Sci. Tech. B. (1996), 14(6), pp. 4129-4133; and Guo, “Recent Progress in Nanoimprint Technology and Its Applications,” J. Phys. D.: Applied. Phys. (2004), 37, R123-R141, the entire contents of all of which are incorporated by reference herein.

Furthermore, in the embodiments disclosed herein that include a hydrophobic layer or coating, the nanotextured surface is first formed on the substrate, either directly on the substrate or on other layers disposed on the substrate, followed by depositing the hydrophobic coating on the textured surface. Alternatively or in addition, if a mold is used, the mold can first be coated with a hydrophobic coating prior to transferring the nanotexture to the surface via the mold. The hydrophobic layer will then transfer to the nanotextured surface when released from the mold. Those skilled in the art will be able to select suitable methods for forming the nanotextured surfaces disclosed herein on the substrate, along with any hydrophobic layers or coatings deposited on the nanotextured surface.

The anti-fog effect of the nanotextured surfaces is attributable to the actual physical texture of the surface. As shown in the Examples, the textured surface prepared in accordance with the embodiments disclosed herein exhibited anti-fog behavior (e.g., Examples 1A, 1B, and 1C), while a portion of the same substrate that was not textured, (e.g., Controls A and B), did not exhibit any anti-fog behavior. Furthermore, the anti-fog properties of the nanotextured surfaces disclosed herein tend to be longer lasting than those from conventional hydrophilic anti-fog coatings, which have a tendency to fade over time as the surfactants that are only physically trapped in the polymeric network of the hydrophilic polymer coating wash out or leach away through extended use. Moreover, the anti-fog properties of the nanotextured surfaces disclosed herein exhibit a level of permanence lasting as long as the surface maintains its nanotexture.

As used in the description of the invention and the appended claims, the singular forms “a,” “an,” and “the” are intended to include the plural forms as well, unless the context clearly indicates otherwise. All references incorporated herein by reference are incorporated in their entirety unless otherwise stated.

Unless otherwise indicated (e.g., by use of the term “precisely”), all numbers expressing quantities, properties such as molecular weight, reaction conditions, and so forth as used in the specification and claims are to be understood as being modified in all instances by the term “about.” Accordingly, unless otherwise indicated, the numerical properties set forth in the following specification and claims are approximations that may vary depending on the desired properties sought to be obtained in embodiments of the present invention.

The following examples are for purposes of illustration only and are not intended to limit the scope of the claims which are appended hereto.

### Examples

### Preparation of the Nanotextured Surface

The nanotexture was prepared on a quartz substrate at Toppan Photomasks Inc. (of Round Rock, Tex.) using e-beam lithography. A thin layer of chrome was deposited on a quartz substrate. The chrome served as a hard mask for the particular nanotexture pattern. A photoresist layer was then deposited on the top of the chrome layer. This layer of photoresist was used to transfer the nanotexture pattern into the chrome using the e-beam lithography. Using the chrome hard mask, the nanotextured pattern was etched into quartz substrate using an anisotropic RIE (Reactive Ion Etch) technique.

Two different patterns of nanotexture were etched into the same quartz substrate. The nanotexture patterns each comprise arrays of vertical pillars having circular lateral cross sections according to the design parameters shown in Table 1. The design parameters used for Example 1 are in accordance with the invention of this disclosure. The design parameters used for Comparative Example 1 are parameters that fall within those taught for the nanotextured array disclosed in U.S. Pat. No. 8,298,649, e.g., a nanotextured periodic array of vertical pillars having a surface fraction (Øₛ) from 3 to 13%. The nanotexture pattern for Example 1 and for Comparative Example 1 were each etched into a circular area having a diameter 0.63 cm on the quartz substrate.

TABLE 1
Design parameters for the nanotexture

| | | | | Surface | Rough- |
|---|---|---|---|---|---|
| | Height h | Diameter | Pitch p | fraction | ness |
| | (nm) | d (nm) | (nm) | (Øₛ) | (r) |
| Example 1 | 120 | 50 | 100 | 19.63% | 2.88 |
| Comparative | 120 | 50 | 138 | 10.31% | 1.99 |
| Example 1 | | | | | |
| (parameters | | | | | |
| from U.S. Pat. | | | | | |
| No. 8,298,649) | | | | | |

The average dimensions of the arrays were measured using scanning electron microscopy, and the results of these measurements are shown in Table 2. Notably, the average dimensions, which represent actual dimensions in each example's array, for Example 1 are in accordance with the dimensions of the invention disclosed herein. For Comparative Example 1, the average dimensions fall within those taught for the nanotextured array in U.S. Pat. No. 8,298,649.

TABLE 2
Average dimensions of the nanotexture

| | Average | Average | Average | Surface | Rough- |
|---|---|---|---|---|---|
| | Height h | Diameter | Pitch p | fraction | ness |
| | (nm) | d (nm) | (nm) | (Øₛ) | (r) |
| Example 1 | 121 | 54.76 | 98.66 | 24.2% | 3.14 |
| Comparative | 120 | 54.92 | 136.75 | 12.67% | 2.11 |
| Example 1 | | | | | |
| (parameters | | | | | |
| from U.S. Pat. | | | | | |
| No. 8,298,649) | | | | | |

FIGS. 3A and 3B both show the scanning electron microscopy images of the nanotextured surfaces at 100,000× magnification. FIG. 3A shows the image of the nanotexture of Example 1. FIG. 3B shows the image of Comparative Example 1. At the same level of magnification, FIGS. 3A and 3B show a much greater distance between the pillars, i.e., the average pitch is larger for Comparative Example 1 as compared to Example 1. The images were provided by Toppan Photomasks, Inc.

Following the measurement of the average dimensions of the array, the nanotextured quartz substrate containing both Example 1 and Comparative Example 1 was then subjected to hydrophobization to add a layer of trichloro-1H,1H,2H,2H-perfluorodecylsilane (FDTS) by molecular vapor deposition in an Applied MST MVD 100 machine (available from Applied MicroStructures Inc. of San Jose, Calif.). To add this layer, the substrate was first activated with plasma O₂ flow at 150 sccm, 200 W for 60 s prior to hydrophobization. The process of hydrophobization was repeated for 6 cycles of vapor deposition to produce the layer of FDTS. Each cycle of vapor deposition involved treatment with deionized water (DI) water at 90° C. for 1 min followed with treatment with FDTS for 30 min at 55° C. Following this round of hydrophobization, the hydrophobized surface corresponding to Example 1, i.e., Example 1 having the deposited hydrophobic FDTS layer, is referred to herein as Example 1A. The hydrophobized surface corresponding to Comparative Example 1, i.e., Comparative Example 1 having the deposited hydrophobic FDTS layer, is referred to herein as Comparative Example 1A. A hydrophobized non-textured surface on the quartz substrate, i.e., a designated non-textured portion of the quartz surface having the deposited hydrophobic FDTS layer, is referred to herein as Control A.

Following the Measurement for the Contact Angles, the Test for Anti-fog Properties, and the Test for Permanence of Anti-Fog Properties, described below for Example 1A, Comparative Example 1A, and Control A, the hydrophobic layer was stripped from the entire quartz substrate containing these surfaces, i.e., the surfaces of Example 1A, Comparative Example 1A, and Control A were all stripped of the hydrophobic FDTS layer. In particular, the quartz substrate was stripped and activated using plasma O₂ flow at 200 sccm, 250 W for 45 min. This process of hydrophobization via molecular vapor deposition of FDTS as described above was then repeated for 6 cycles to produce a new layer of FDTS over the stripped quartz substrate. In particular, each cycle of vapor deposition involved treatment with DI water at 90° C. for 1 min followed with treatment with FDTS for 30 min at 55° C. Following this round of hydrophobization, the hydrophobized nanotextured surface on the subtract corresponding to Example 1, i.e., Example 1 having the deposited hydrophobic FDTS layer, is referred to herein as Example 1B. The hydrophobized nanotextured surface corresponding to Comparative Example 1, i.e., Comparative Example 1 having the deposited hydrophobic FDTS layer, 1 is referred to herein as Comparative Example 1B. The hydrophobized non-textured surface on the quartz substrate (the portion previously designated as Control A), i.e., a designated non-textured portion of the quartz surface having the deposited hydrophobic FDTS layer (as applied over the stripped section of Control A), is referred to herein as Control B.

Following the Measurement for the Contact Angles, the Test for Anti-fog Properties, and the Test for Reflectance described below for Example 1B, Comparative Example 1B, and Control B, the hydrophobic layer was stripped from the entire quartz substrate containing these surfaces, i.e., Example 1B, Comparative Example 1B, and Control B were all stripped of the hydrophobic FDTS layer. In particular, the hydrophobic FDTS layer on the quartz substrate was stripped using plasma O₂ flow at 200 sccm, 250 W for 60 s. The stripped quartz surface corresponding to Example 1 is referred to herein as Example 1C. The stripped quartz surface corresponding to Comparative Example 1 is referred to herein as Comparative Example 1C. The stripped portion of the substrate the previously corresponded to Control B is referred to herein as Control C.

Measurement of the Contact Angles:

The contact angles were measured for each of Examples 1A-1C and Comparative Examples 1A-1C, as well as a Controls A-C, i.e., the non-nanotextured section of the quartz substrate, using the sessile drop method. In particular, the contact angles were measured using a 2 μl water drop on a VCA Optima goniometer (available from AST Products, Inc. of Billerica, Mass.). The results are shown in Table 3.

TABLE 3
Contact angle of water

| Sample | Contact angle |
|---|---|
| Example 1A | 145° |
| Comparative Example 1A | 120° |
| Control A | 60° |
| Example 1B | >150° |
| Comparative Example 1B | 136° |
| Control B | 116° |
| Example 1C | 120° |
| Comparative Example 1C | 85° |
| Control C | 60° |

As shown in Table 3, the nanotexture of Example 1A was superhydrophobic. Notably, the non-nanotextured Control A was hydrophobized along with the Example 1A and Comparative Example 1A. Because the Control has a contact angle less than 90° (i.e., indicating a hydrophilic surface), it appears that the hydrophobization of the quartz substrate in general, i.e., as applied to Example 1A, to Comparative Example 1A, and to the Control A, was partial or unsuccessful because one of ordinary skill in the art would expect the contact angle of Control A to be greater than 90° following the application of the hydrophobic layer. In view of the foregoing and the Test for Anti-fog Properties described below, one of ordinary skill in the art will understand that the hydrophobic layer as disclosed herein is optional with respect to the anti-fog performance of the nanotextured surfaces. Upon repeating the hydrophobization process after a more intense O₂ plasma activation (i.e., higher O₂ plasma flowrate and at a higher power level), the contact angle measured on the non-textured area of Control B increased to 116°. Notably, each of the contact angles for Example 1B and Comparative Example 1B increased to 150° and 136°, respectively. Furthermore, following the removal of the hydrophobic FDTS layer, the contact angles significantly decreased for the respective surfaces. Specifically, the contact angle of Control C was again 60° and those of Example 1C and Comparative Example 1C fell to 120° and 85°, respectively.

Test for Anti-Fog Properties:

In a 1000 ml glass beaker, 800 ml of deionized water was heated to different temperatures (50°, 60°, and 70° C.) while stirring. The beaker was covered with a watch glass during the heating process. After the desired temperature was reached and stabilized, the heat was turned off. Immediately, the watch glass was removed and replaced with the quartz substrate. The quartz substrate was placed with the nanotextured surfaces of Example 1 and Comparative Example 1, as well as the Control surface, facing the hot water. The development of fog over the quartz substrate was recorded visually for 3 minutes or longer.

Under this test, a surface was determined to have anti-fog properties if it remained fog free on exposure to the water vapor. In general, as the temperature to which the water is heated increases, the fog created will be denser. Thus, under this test, a surface which remains fog free on testing with water heated to higher temperature is determined to have better anti-fog properties. The performance of the quartz substrate subjected to anti-fog test with water at 50° C., 60° C., and 70° C. after 3, 10 and 30 minutes of test time is shown in Table 4.

TABLE 4
Anti-fog properties of the quartz substrate

| | Water temperature | | | | | |
|---|---|---|---|---|---|---|
| | 50° C. | | | 60° C. | | |
| | Test Duration | | | | | |
| | 3 min | 10 min | 30 min | 3 min | 10 min | 30 min |
| Example 1A | No fog | No fog | No fog | No fog | No fog | No fog |
| Comparative | Sporadic | Fog | Fog | Sporadic | Fog | Fog |
| Example 1A | fogging and | | | fogging and | | |
| | defogging | | | defogging | | |
| Control A | Fog | Fog | Fog | Fog | Fog | Fog |
| Example 1B | No fog | No fog | No fog | No fog | No fog | No fog |
| Comparative | Fog | Fog | Fog | Fog | Fog | Fog |
| Example 1B | | | | | | |
| Control B | Fog | Fog | Fog | Fog | Fog | Fog |
| Example 1C | No fog; But | No fog; But | No fog; But | No fog; But | No fog; But | No fog; |
| | water layer | water layer | water layer | water layer | water layer | But water |
| | builds up | builds up | builds up | builds up | builds up | layer |
| | after 1 min | after 1 min | after 1 min | after 40 s. | after 40 s. | builds up |
| | | | | | | after 40 s. |
| Comparative | Sporadic | Sporadic | Sporadic | Fog | Fog | Fog |
| Example 1C | fogging and | fogging and | fogging and | | | |
| | defogging; | defogging; | defogging; | | | |
| | Water layer | Water layer | Water layer | | | |
| | build up after | build up | build up | | | |
| | 1 min | after 1 min | after 1 min | | | |
| Control C | Fog | Fog | Fog | Fog | Fog | Fog |

| | Water temperature | | |
|---|---|---|---|
| | 70° C. | | |
| | Test Duration | | |
| | 3 min | 10 min | 30 min |
| Example 1A | No fog | No fog | No fog |
| Comparative Example 1A | Initial fog, then sporadic | Fog | Fog |
| | fogging and defogging | | |
| Control A | Fog | Fog | Fog |
| Example 1B | No fog | No fog | No fog |
| Comparative Example 1B | Fog | Fog | Fog |
| Control B | Fog | Fog | Fog |
| Example 1C | No fog; But water layer | No fog; But water layer | No fog; But water |
| | builds up after 20 s. | builds up after 20 s. | layer builds up |
| | | | after 20 s. |
| Comparative Example 1C | Fog | Fog | Fog |
| Control C | Fog | Fog | Fog |

As shown in Table 4, Examples 1A and 1B remained clear throughout the entire 30 minute duration of the anti-fog test carried out with water at 50° C. In contrast, the anti-fog performance of Comparative Examples 1A and 1B was poorer. Comparative Example 1A remained clear for the first 20 seconds but subsequently fogged-up. The area then cleared up after another 10-15 seconds and fogged-up again. This sporadic fogging and defogging was observed for about 3 min. Similar performance was observed with water at 60° C. as shown in Table 4. However, as shown in Table 4, the difference at 70° C. in the anti-fog performance of the two nanotextured surfaces is more pronounced. Examples 1A and 1B remained completely clear throughout the test duration of 30 min at 70° C. whereas Comparative Example 1A instantly fogged up and then exhibited sporadic fogging and defogging for 3 min, followed by consistent fog beyond 3 minutes at 70° C. Comparative Example 1B fogged immediately during the respective anti-fog tests carried out with water at 50° C., 60° C., and 70° C.

The anti-fog tests were also carried out on the substrate after complete removal of the hydrophobic FDTS layer for Example 1C, Comparative Example 1C, and Control C. Although Example 1C did not develop fog during the anti-fog test, an optical distortion was observed due to the build-up of a water layer after about 1 minute. However, the anti-fog performance was still superior to that of Comparative Example 1C and Control C. Comparative Example 1C exhibited sporadic fogging and defogging during anti-fog test conducted at 50° C. A water layer build-up was also observed for Comparative Example 1C after 1 minute of test duration at 50° C. Comparative Example 1C fogged immediately on testing with water at 60° C. and 70° C. Control C fogged immediately under all test conditions.

Test for Permanence of Anti-Fog Properties:

The followings steps were conducted to test for permanence of anti-fog properties for Example 1A, Comparative Example 1A, and Control A:

1. The nanotextured quartz substrate was tested for anti-fog property at 60° C. for 3 min using the procedure previously described.

2. Subsequently, the substrate was dried by blowing compressed air.

3. The anti-fog test was repeated with the dried substrate.

4. Steps 1-3 were repeated twice.

The results of this test are shown in Table 5.

TABLE 5
Results of Test for Permanence of Anti-fog

| Sample | Anti-fog test - 1 | Anti-fog test - 2 | Anti-fog test - 3 |
|---|---|---|---|
| Example 1A | No fog | No fog | No fog |
| Comparative | Fogging after 20 s | Fog | Fog |
| Example 1A | | | |
| Control A | Fog | Fog | Fog |

As shown in Table 5, Example 1A remained fog-free during all three anti-fog tests, thereby indicating permanence of the anti-fog properties. In contrast, Comparative Example 1A remained fog-free only for the initial 20 seconds in the first anti-fog test (i.e., Anti-fog test-1), and during the second and third anti-fog tests (i.e., Anti-fog test-2 and Anti-fog test-3), Comparative Example 1A fogged immediately and remained fogged. The untextured Control A area on the quartz substrate did not exhibit any anti-fog properties under this test.

Overall, the nanotextured surface of Examples 1A, 1B, and 1C prepared in accordance with the invention disclosed herein demonstrated no fogging at water temperatures of 50° C., 60° C., and 70° C. as shown in Table 4 (although Example 1C did exhibit a layer of water build-up), as well as demonstrated permanence of the anti-fog property for Example 1A as shown in Table 5.

Test for Reflectance

Specular reflectance was measured by scanning at several positions in the nanotextured surfaces, i.e., Example 1B and Comparative Example 1B, and the non-textured surface, i.e., Control B, of the quartz substrate using PERKINELMER Lambda 1050 Spectrophotometer (available from Perkin Elmer Inc. of Waltham, Mass.) equipped with the Universal Reflectance Accessory (URA). The incidence angle of 8° was used for all the scans. FIG. 6 shows a plot of the absolute specular reflectance versus wavelength in the range 200-1200 nm for Example 1B, Comparative Example 1B, and Control B. As shown in FIG. 6, the reflectance of Example 1B and Comparative Example 1B were comparable with that of Control B in the wavelength range of 200-1200 nm. Notably, the reflectance of Example 1B was indeed about 0.5-1.5% lower than that of Control B over this wavelength range. Thus, based on the reflectance spectra shown in FIG. 6, one skilled in the art would understand that the nanotextured surface disclosed in Example 1B is non-reflective and does not contribute to the reflectance of the quartz substrate.

It will be understood that various changes may be made without departing from the scope of the invention, which is not to be considered limited to what is described in the description.

What is claimed is:

1. An anti-fog, transparent nanotextured surface for a transparent substrate, the nanotextured surface comprising an array of vertical pillars comprising:
a surface fraction (Øₛ) of the array from 14% to 65%;
an average pitch of the array from 45 to 125 nm;
an average height of the pillars from 50 to 150 nm; and
a roughness from 2.5 to 7.5.

2. The nanotextured surface of claim 1, wherein a lateral cross section of individual pillars in the array is circular or equiangular polygonal.

3. The nanotextured surface of claim 1, wherein:
when the array comprises pillars having a circular lateral cross section, the pillars have an average diameter from 25 to 100 nm, or
when the array comprises pillars having a square lateral cross section, the pillars have an average side length from 25 to 100 nm.

4. The nanotextured surface of claim 1, wherein the surface fraction (Øₛ) of the array ranges from 19% to 65%.

5. The nanotextured surface of claim 1, wherein the surface fraction (Øₛ) of the array ranges from 24% to 65%.

6. The nanotextured surface of claim 1, wherein the surface comprises at least one layer selected from the group consisting of a hardened composition, a hardenable composition, and a metal oxide.

7. The nanotextured surface of claim 1, wherein the surface comprises at least one layer of silica.

8. The nanotextured surface of claim 1, wherein the surface has a percent reflectance that is less than or equal to the percent reflectance of a comparable surface without the nanotexture, where the comparable surface is the same material as the surface but without the nanotexture.

9. The nanotextured surface of claim 1, wherein at least a portion of the nanotextured surface has at least one hydrophobic layer deposited thereon.

10. The nanotextured surface of claim 9, wherein a thickness of the at least one hydrophobic layer ranges from 1 to 10 nm.

11. The nanotextured surface of claim 1, wherein individual pitches in the array vary.

12. An article comprising a transparent substrate and at least a portion of the nanotextured surface of claim 1 formed on the substrate.

13. The article of claim 12, wherein the at least a portion of the nanotextured surface is an outer layer of the article.

14. The article of claim 12 further comprising a layer selected from the group consisting of a primer layer, an abrasion-resistant layer, an anti-reflective layer, and combinations thereof disposed between the substrate and the nanotextured surface.

15. The article of claim 12, wherein the substrate is an ophthalmic lens.
